(19) United States
(12) Patent Application Publication
(10) Pub. No.: US 2020/0246946 A1
(43) Pub. Date: Aug. 6, 2020

(54) RATCHET TOOL

(71) Applicant: Kong Ding Industrial Co., Ltd., Taichung City (TW)

(72) Inventor: Zu-Shung SHU, Taichung City (TW)

(21) Appl. No.: 16/449,509

(22) Filed: Jun. 24, 2019

(30) Foreign Application Priority Data
Jan. 31, 2019 (TW) 108103830

(51) Int. Cl. B25B 13/46; B25B 23/00; B25B 23/16

(52) U.S. Cl. CPC B25B 13/465; B25B 23/16; B25B 23/0007

(57) ABSTRACT

A ratchet tool includes a first rotating assembly including a seat, a first pawl, and a second pawl. The seat defines a first recess and a second recess. The first pawl is pivotally engaged in the first recess and the second pawl is pivotally engaged in the second recess respectively. The first pawl has a first protrusion and the second pawl has a second protrusion respectively. Further, a second rotating assembly including a ratchet wheel. The ratchet wheel includes the seat inserted therein. Further, a direction control assembly includes a shifter and a pushing member. The shifter is rotatable with respect to the seat between a first position in which the pushing member urges the first protrusion, a second position in which the pushing member urges the first and the second protrusions, and a third position in which the pushing member urges the second protrusion.

### BACK2ROUND OF THE INVENTION

### 1. Field of the Invention

The present invention relates to a tool and, particularly, to a ratchet tool.

### 2. Description of the Related Art

TW Pat. No. M425742 shows a ratcheting mechanism of a ratchet hand tool including a main body, a ratchet wheel, two pawls, and a control disc. The main body is provided with two axially recessed chambers. Each chamber includes a bottom surface defining a pivot hole. Each pawl has a side including a pivot protruding therefrom. The pivots of the two pawls are pivotally engaged in the pivot holes of the two chambers respectively. The ratchet wheel is pivotally connected to the main body and is selectively engagable with the two pawls. The ratchet wheel has teeth and engagable with teeth of the pawls. The control disc is also pivotally connected to the main body. Each pawl includes a block received in a slot defined by the control disc. By raotating the control disc, the two pawls can engage and/or disengage with the ratchet wheel.

The problem is that when the control disc pushes the pawls, the pivots are liable to lean, causing each pawls to incline from its original position. Consequently, a user are unable to use the ratchet hand tool the teeth to apply a desired torque because the pawls and the teeth of the ratchet wheel can not engage properly.

The present invention is, therefore, intended to obviate or at least alleviate the problems encountered in the prior art.

### SUMMARY OF THE INVENTION

According to the present invention, a ratchet tool includes a first rotating assembly including a seat, a first pawl, and a second pawl. The seat includes an end defining a first recess and a second recess. The first pawl is pivotally engaged in the first recess and the second pawl is pivotally engaged in the second recess respectively. The first pawl has a first protrusion and the second pawl has a second protrusion respectively. Further, a second rotating assembly including a ratchet wheel. The ratchet wheel includes the seat inserted therein. Further, a direction control assembly includes at least one shifter and a first pushing member. The at least one shifter is rotatable with respect to the seat between a first position, a second position, and a third position. The first pushing member is disposed on the at least one shifter.

When the at least one shifter is rotated to the first position, the first pushing member is adjacent to and urges against the first protrusion of the first pawl to engage teeth of the first pawl with toothed portion of the ratchet wheel and is away from the second protrusion to disengage teeth of the second pawl from the toothed portion of the ratchet wheel.

When the at least one shifter is rotated to the second position, the first pushing member is adjacent to and urges against the first protrusion of the first pawl to engage the teeth of the first pawl with the toothed portion of the ratchet wheel and the second protrusion of the second pawl to engage the teeth of the second pawl with the toothed portion of the ratchet wheel.

When the at least one shifter is rotated to the third position, the first pushing member is away from the first protrusion of the first pawl to disengage the teeth of the first pawl from the toothed portion of the ratchet wheel and is adjacent to and urges against the second protrusion to engage the teeth of the second pawl with the toothed portion of the ratchet wheel.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings. 14

### BRIEF DESCRIPTION OF THE DRAWINGS

FIG. 1 is a perspective view of a ratchet tool in accordance with a first embodiment of the present invention.

FIG. 2 is an exploded perspective view of the ratchet tool of FIG. 1.

FIG. 3 is a cross-sectional view of the ratchet tool of FIG. 1.

FIG. 4 is another cross-sectional view of the ratchet tool of FIG. 1 and shows the ratchet tool in a first mode.

FIG. 5 is a cross-sectional view of the ratchet tool of FIG. 1 and shows the ratchet tool in a second mode.

FIG. 6 is a cross-sectional view of the ratchet tool of FIG. 1 and shows the ratchet tool in a third mode.

FIG. 7 is a perspective view of a ratchet tool in accordance with a second embodiment of the present invention.

FIG. 8 is an exploded perspective view of the ratchet tool of FIG. 7.

FIG. 9 is a cross-sectional view of the ratchet tool of FIG. 7.

FIG. 10 is a perspective view of a ratchet tool in accordance with a third embodiment of the present invention.

FIG. 11 is an exploded perspective view of the ratchet tool of FIG. 10.

### DETAILED DESCRIPTION OF THE INVENTION

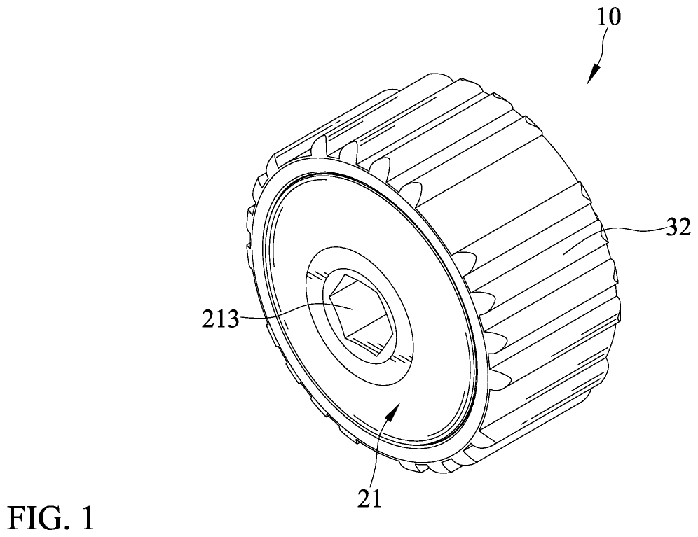

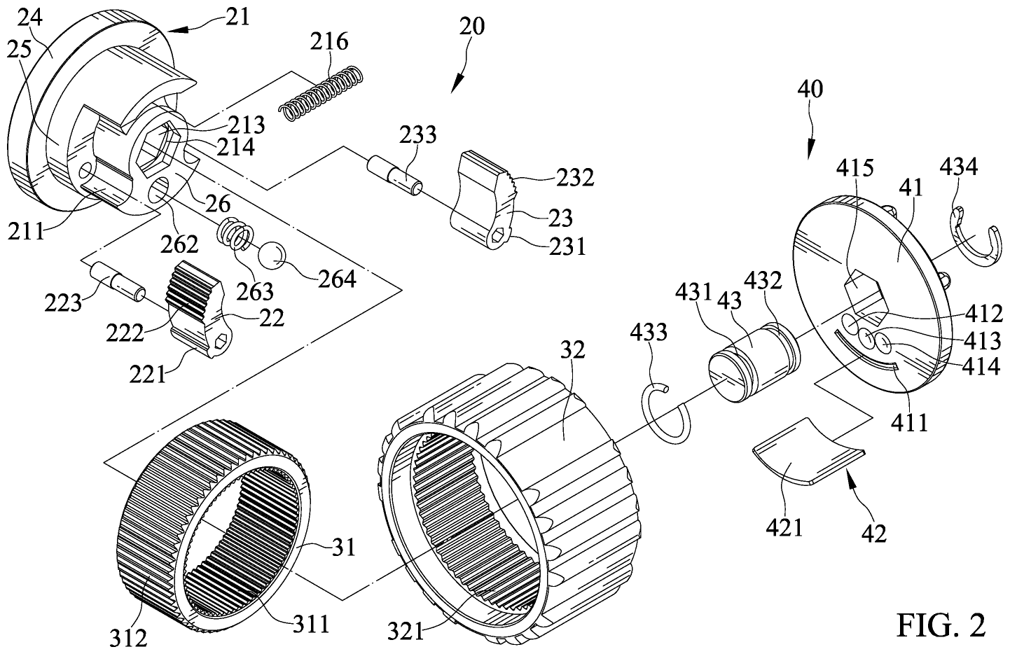

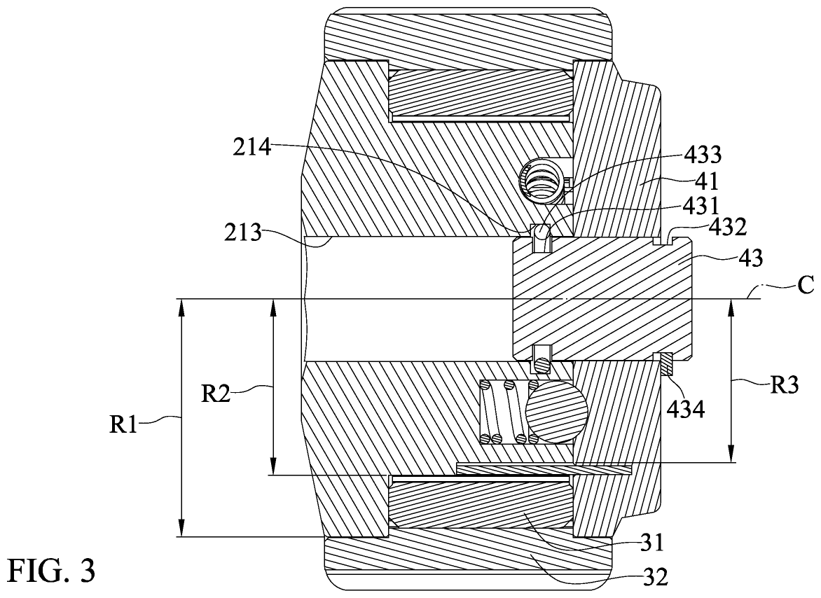

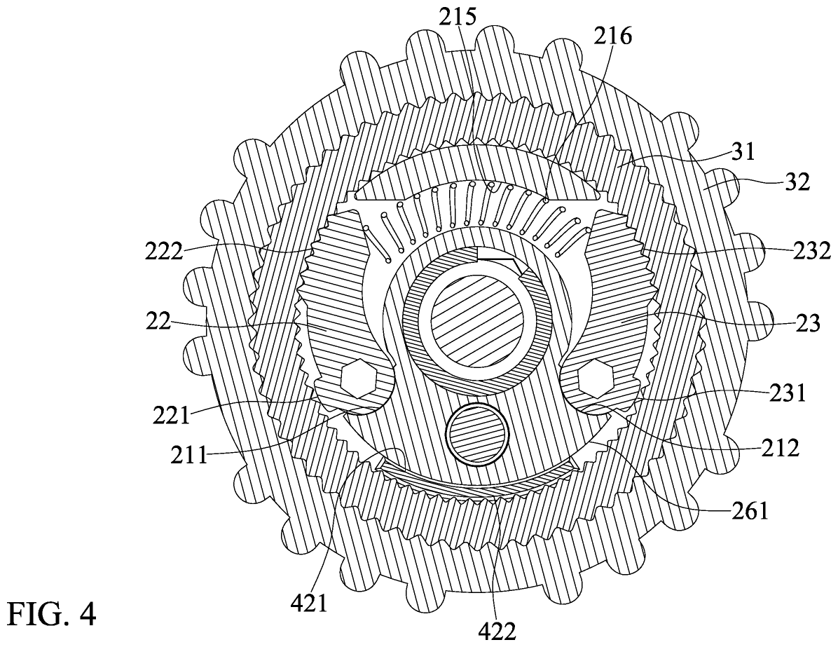

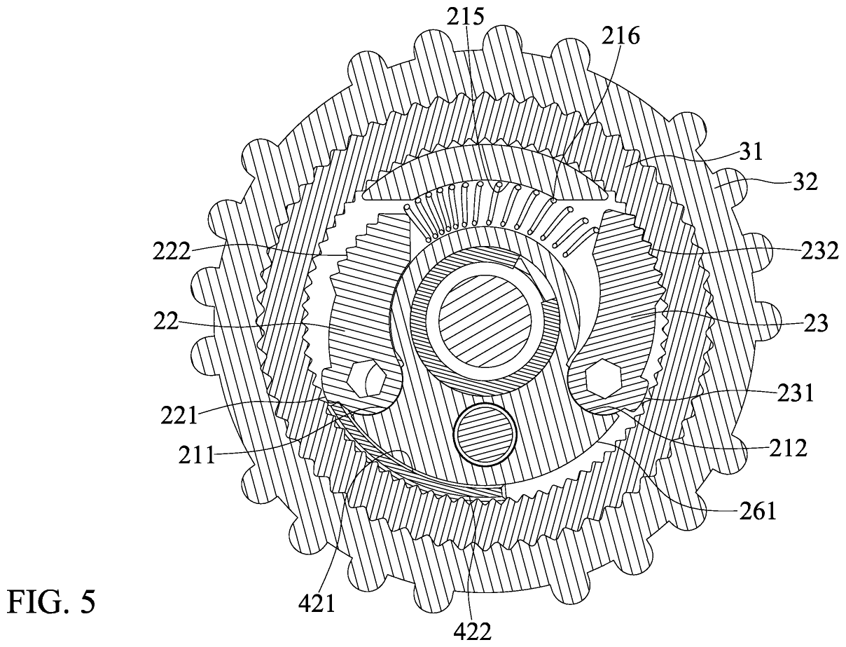

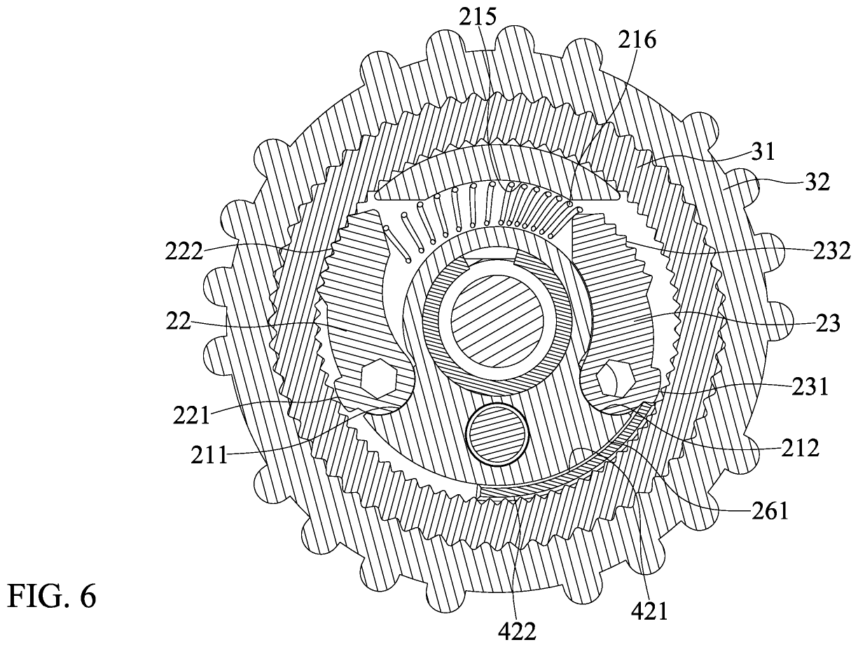

FIGS. 1 through 6 show a ratchet tool 10 in accordance with a first embodiment of the present invention. The ratchet tool 10 includes a rotating assembly 20. The rotating assembly 20 includes a seat 21, a pawl 22, and a pawl 23. The seat 21 includes an end defining a recess 211, a recess 212, and an insert hole 213. The pawl 22 is pivotally engaged in the recess 211 and the pawl 23 is pivotally engaged in the recess 212 respectively. The pawl 22 is pivotal about a pivot 223 and the pawl 23 is pivotal about a pivot 233 respectively. The pawl 22 and the pawl 23 respectively pivot about a first axis and a second axis. The first and the second axes are parallel to a center axis C of the seat 21. The pawl 22 has a protrusion 221 and the pawl 23 has a protrusion 231 respectively. The end of the seat 21 defines a receptacle 215 communicating with the recess 211 and the recess 212. The receptacle 215 includes a resilient member 216 disposed therein. The resilient member 216 is retained between the pawls 22 and 23 and has one end being adjacent to and urging against the pawl 22 and another end being adjacent to and urging against the pawl 23. The seat 21 has a portion 24, a portion 25, and a portion 26 of different radii. The portions 24, 25, and 26 respectively has a radius R1, a radius R2, and a radius R3 about a center axis C of the seat 21. The radius R1 is greater than the radius R2. The radius R2 is greater than the radius R3. The portion 25 is disposed between the portion 24 and the portion 26. The portion 25 includes an end defining the recess 211, the recess 212, and the receptacle 215. The recess 211, the recess 212, and the receptacle 215 are adjacent to the portion 26. A circumference of the portion 26 defines a guiding surface 261. The ratchet tool 10 also includes a rotating assembly 30. The rotating assembly 30 includes a ratchet wheel 31. The ratchet wheel 31 includes the seat 21 inserted therein. The ratchet wheel 31 is disposed non-rotatably on the seat 21. The ratchet wheel 31 includes an inner periphery including a toothed portion 311 and a toothed portion 312. The toothed portion 311 of the ratchet wheel 31 includes a plurality of teeth protruding radially from the inner periphery of the ratchet wheel 31. The protrusion 221 and the teeth 222 of the pawl 22 face the toothed portion 311 of the ratchet wheel 31 oppositely. The protrusion 231 and the teeth 232 of the pawl 23 face the toothed portion 311 of the ratchet wheel 31 oppositely. Further, a direction control assembly 40 includes a shifter 41 and a pushing member 42. The pawls 22 and 23 are disposed between the seat 21 and the shifter 41 with one of two opposite sides of each of the pawls 22 and 23 being adjacent to the seat 21 and the other side being adjacent to the shifter 41. The protrusion 221 and the teeth 222 of the pawl 22 don't protrude into the shifter 41. The protrusion 231 and the teeth 232 of the pawl 23 don't protrude into the shifter 41. The protrusion 221 and the teeth 222 of the pawl 22 protrude from a side of the pawl 22 which extends between the two opposite sides. The protrusion 231 and the teeth 232 of the pawl 23 protrude from a side of the pawl 22 which extends between the two opposite sides. The shifter 41 is rotatable with respect to the seat 21 between a first position, a second position, and a third position. The pushing member 42 is configured to urge protrusions 221 and 231. The pushing member 42 has a depth greater than depths of the protrusions 221 and 231. The pushing member 42 is disposed on the shifter 41. The shifter 41 defines a slot 411 and the pushing member 42 is retained in the slot 411. The pushing member 42 and the guiding surface 261 have the same curvature. An inner arcuate surface 421 of the pushing member 42 and the guiding surface 261 face oppositely. The inner arcuate surface 421 has a radius not smaller than the radius R3. An outer arcuate surface 422 of the pushing member 42 has a greater radius of curvature than the inner arcuate surface 421 and less than the radius R2. The shifter 41 also defines a through hole 415. The direction control assembly 40 includes a shaft 43 retained in the insert hole 213 and the through hole 415. The shifter 41 and the shaft 43 rotate together upon rotating the at least one shifter 41. A retainer 433 preventing disengagement of the seat 21 from the shaft 43 and a retainer 434 preventing disengagement of the shifter 41 from the shaft 43 respectively. The retainer 433 is received by a groove 214 extending radially outward from the insert hole 213 and a groove 431 defined by an outer periphery of the shaft 43 circumferentially. The retainer 434 is received by a groove 432 defined by the outer periphery of the shaft 43 circumferentially. The shifter 41 is disposed between the grooves 431 and 432.

When the shifter 41 is rotated to the first position, the pushing member 42 is adjacent to and urges against the protrusion 221 of the pawl 22 to engage teeth 222 of the pawl 22 with the toothed portion 311 of the ratchet wheel 31 and is away from the protrusion 231 to disengage teeth 232 of the pawl 23 from the toothed portion 311 of the ratchet wheel 31 and, the ratchet wheel 31 is rotatable with respect to the seat 21 in a first direction.

When the shifter 41 is rotated to the second position, the pushing member 42 is adjacent to and urges against the protrusion 221 of the pawl 22 to engage the teeth 222 of the pawl 22 with the toothed portion 311 of the ratchet wheel 31 and the protrusion 231 of the pawl 23 to engage the teeth 232 of the pawl 23 with the toothed portion 311 of the ratchet wheel 31.

When the shifter 41 is rotated to the third position, the pushing member 42 is away from the protrusion 221 of the pawl 22 to disengage the teeth 222 of the pawl 22 from the toothed portion 311 of the ratchet wheel 31 and is adjacent to and urges against the protrusion 231 to engage the teeth 232 of the pawl 23 with the toothed portion 311 of the ratchet wheel 31 and, the ratchet wheel 31 is rotatable with respect to the seat 21 in a second direction which is in a direction opposite to the first direction.

Further, a detent ball 264 selectively positioning the shifter 41 in relation to the seat 21 between the first, the second, and the third positions disposed between the seat 21 and the shifter 41. The detent ball 264 is adjacent to and urged by a resilient member 263 to a positioning hole 412, a positioning hole 413, and a positioning hole 414 selectively upon rotating the shifter 41 to the first position, the second position, and the third position. The seat 21 defines a cavity 262 and the resilient member 263 is received by the cavity 262. The at least one shifter 41 includes a side defining the positioning hole 412, the positioning hole 413, and the positioning hole 414.

Further, a body 32 includes the rotating assembly 20, the rotating assembly 30, and the direction control assembly 40 disposed therein. The body 32 is configured as a handle which enables a user to operate the ratchet tool to apply a torque easier. The body 32 extends on an outer periphery of the ratchet wheel 31 circumferentially. The body 32 is configured to be adapted to be grasped by one hand when operating the ratchet tool 10.

An inner periphery of the body 32 forms a toothed portion 321 meshing with the toothed portion 312. The ratchet wheel 31 is disposed non-rotatanly in the body 32.

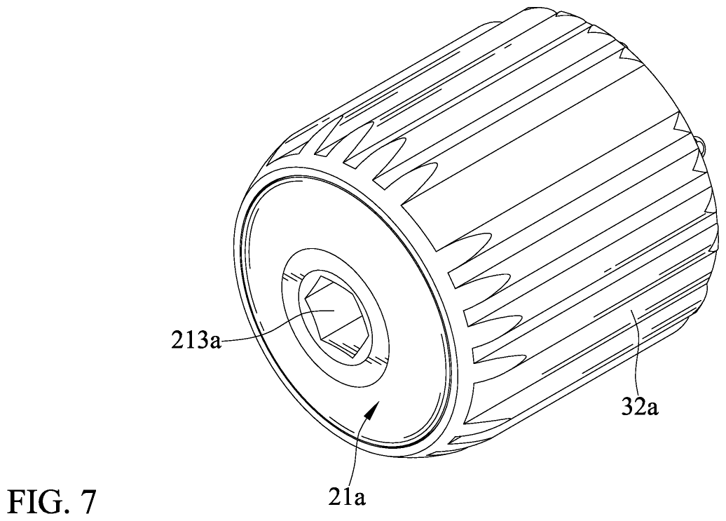

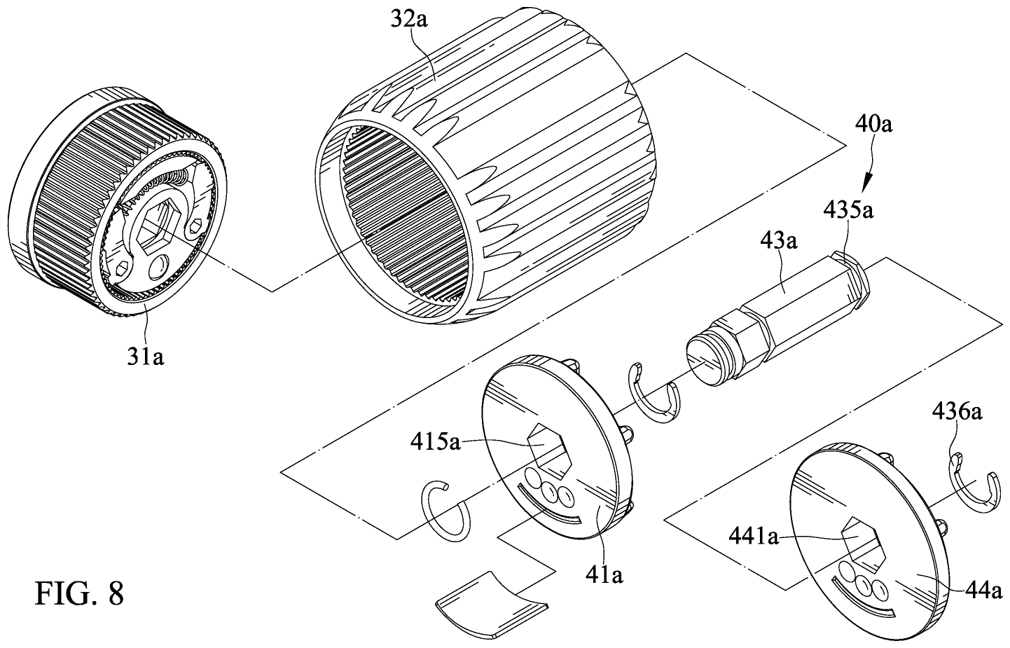

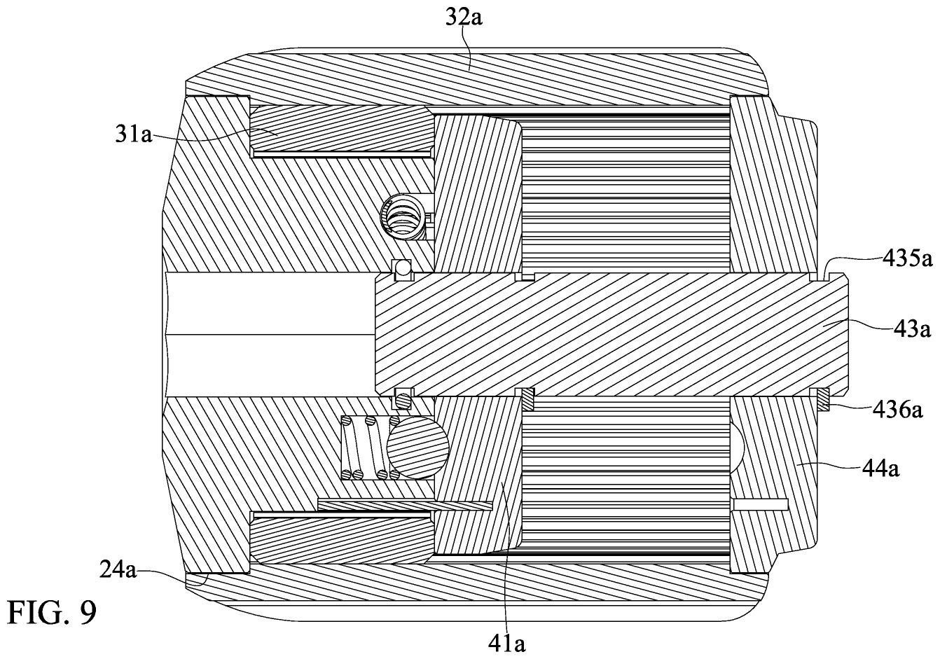

FIGS. 7 through 9 show a ratchet tool head in accordance with a second embodiment of the present invention, and the same numbers are used to correlate similar components of the first embodiment, but bearing a letter a. A ratchet wheel 31a includes a seat 21a inserted therein. The seat 21a defines an insert hole 213a. The second embodiment is similar to the first embodiment except that a direction control assembly 40a includes a shifter 41a and a shifter 44a. The two shifters 41a and 44a are arranged in a spaced relationship. The shifter 41a defines a through hole 415a and the shifter 44a defines a through hole 441a respectively. The through holes 415a and 441a have hexagonal cross sections. A shaft 43a is retained in the insert hole 213a, the through hole 415a, and the through hole 441a. A portion of the shaft 43a extending between the two shifters 41a and 44a has a hexagonal cross section. A retainer 436a preventing disengagement of the shifter 44a from the shaft. A groove 435a is defined by an outer periphery of the shaft circumferentially. The retainer 436a is received by the groove 435a. The shifter 41a and the shifter 44a are disposed in a spaced relationship. A body 32a has a greater depth than the body 32.

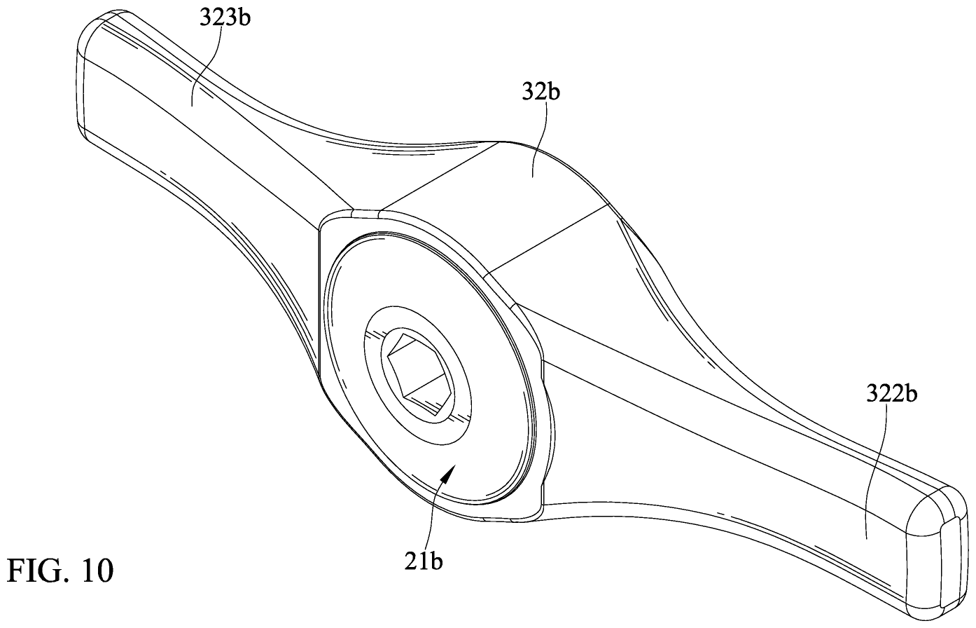

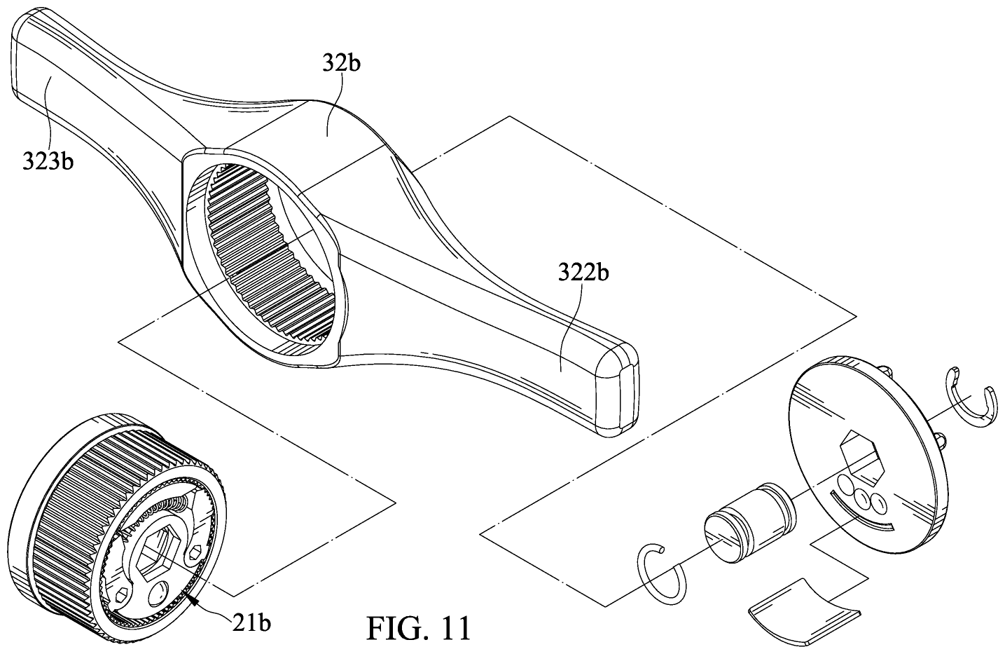

FIGS. 10 and 11 show a ratchet tool head in accordance with a third embodiment of the present invention, and the same numbers are used to correlate similar components of the first embodiment, but bearing a letter b. A ratchet wheel includes a seat 21b inserted therein. The third embodiment is similar to the first embodiment except that a body 32b receiving a direction control assembly 40a includes two grip portions 322b and 323b extending in different directions. The two grip portions 322b and 323b extend oppositely.

In view of the foregoing, the ratchet tool 10 is designed to sustain the pawls 22 and 23 on a predetermined plane horizontally so gear mesh misalignment problem between the pawls 22 and 23 and the ratchet wheels 31 can be solved. Further, since the pushing member 42 has a depth greater than depths of the protrusions 221 and 231, the protrusions 221 and 231 are not tilted and can sustain in the predetermined horizontal position.

The foregoing is merely illustrative of the principles of this invention, and various modifications can be made by those skilled in the art without departing from the scope and spirit of the invention.

What is claimed is:

1. A ratchet tool comprising:
a first rotating assembly including a seat, a first pawl, and a second pawl, wherein the seat includes an end defining a first recess and a second recess, wherein the first pawl is pivotally engaged in the first recess and the second pawl is pivotally engaged in the second recess respectively, and wherein the first pawl has a first protrusion and the second pawl has a second protrusion respectively;
a second rotating assembly including a ratchet wheel, wherein the ratchet wheel includes the seat inserted therein; and
a direction control assembly including at least one shifter and a pushing member, wherein the at least one shifter is rotatable with respect to the seat between a first position, a second position, and a third position, wherein the pushing member is disposed on the at least one shifter, wherein when the at least one shifter is rotated to the first position, the pushing member is adjacent to and urges against the first protrusion of the first pawl to engage teeth of the first pawl with toothed portion of the ratchet wheel and is away from the second protrusion to disengage teeth of the second pawl from the toothed portion of the ratchet wheel, wherein when the at least one shifter is rotated to the second position, the pushing member is adjacent to and urges against the first protrusion of the first pawl to engage the teeth of the first pawl with the toothed portion of the ratchet wheel and the second protrusion of the second pawl to engage the teeth of the second pawl with the toothed portion of the ratchet wheel, and wherein when the at least one shifter is rotated to the third position, the pushing member is away from the first protrusion of the first pawl to disengage the teeth of the first pawl from the toothed portion of the ratchet wheel and is adjacent to and urges against the second protrusion to engage the teeth of the second pawl with the toothed portion of the ratchet wheel.

2. The ratchet tool as claimed in claim 1, wherein the toothed portion of the ratchet wheel includes a plurality of teeth protruding radially from an inner periphery of the ratchet wheel.

3. The ratchet tool as claimed in claim 1, wherein the first and the second pawls are disposed between the seat and the at least one shifter with one of two opposite sides of each of the first and the second pawls being adjacent to the seat and the other side being adjacent to the at least one shifter, and wherein the first protrusion and the teeth of the first pawl as well as the second protrusion and the teeth of the second pawl don't protrude into the at least one shifter.

4. The ratchet tool as claimed in claim 3, wherein the first protrusion and the teeth of the first pawl face the toothed portion of the ratchet wheel oppositely, and wherein the second protrusion and the teeth of the second pawl face the toothed portion of the ratchet wheel oppositely.

5. The ratchet tool as claimed in claim 1, wherein the end of the seat defines a receptacle communicating with the first recess and the second recess, wherein the receptacle includes a resilient member disposed therein, and wherein the resilient member is retained between the first and the second pawls and has one end being adjacent to and urging against the first pawl and another end being adjacent to and urging against the second pawl.

6. The ratchet tool as claimed in claim 1, wherein the seat has a first portion, a second portion, and a third portion of different radii, wherein the first, the second, and the third portions respectively has a first radius, a second radius, and a third radius about a center axis of the seat, wherein the second portion is disposed between the first portion and the third portion, wherein the second portion includes an end defining the first recess, the second recess, and the receptacle, and wherein the first recess, the second recess, and the receptacle are adjacent to the third portion.

7. The ratchet tool as claimed in claim 6, wherein a circumference of the third portion defines a guiding surface, wherein the pushing member and the guiding surface have the same curvature, wherein an inner arcuate surface of the pushing member and the guiding surface face oppositely, wherein the inner arcuate surface has a radius not smaller than the third radius, and wherein an outer arcuate surface of the pushing member has a greater radius of curvature than the inner arcuate surface and less than the second radius.

8. The ratchet tool as claimed in claim 7, wherein the at least one shifter defines a slot and the pushing member is retained in the slot.

9. The ratchet tool as claimed in claim 1, wherein the seat defines an insert hole and the at least one shifter defines a first through hole respectively and the direction control assembly includes a shaft retained in the insert hole and the first through hole, and wherein the at least one shifter and the shaft rotate together upon rotating the at least one shifter.

10. The ratchet tool as claimed in claim 9 further comprising a first retainer preventing disengagement of the seat from the shaft and a second retainer preventing disengagement of the at least one shifter from the shaft respectively, wherein the first retainer is received by a first groove extending radially outward from the insert hole and a second groove defined by an outer periphery of the shaft, wherein the second retainer is received by a third groove defined by the outer periphery of the shaft, and wherein the at least one shifter is disposed between the second and the third grooves.

11. The ratchet tool as claimed in claim 1 further comprising a detent ball selectively positioning the at least one shifter in relation to the seat between the first, the second, and the third positions disposed between the seat and the at least one shifter, wherein the detent ball is adjacent to and urged by a resilient member to a first positioning hole, a second positioning hole, and a third positioning hole selectively upon rotating the at least one shifter to the first position, the second position, and the third position, wherein the seat defines a cavity and the resilient member is received by the cavity, and wherein the at least one shifter includes a side defining the first positioning hole, the second positioning hole, and the third positioning hole.

12. The ratchet tool as claimed in claim 1 further comprising a body including the first rotating assembly, the second rotating assembly, and the direction control assembly disposed therein, and wherein the body is configured as a handle.

13. The ratchet tool as claimed in claim 12, wherein the an inner periphery of the body forms a first toothed portion and an outer periphery of the ratchet wheel forms a second toothed portion meshing with the first toothed portion.

14. The ratchet tool as claimed in claim 12, wherein the body extends on an outer periphery of the ratchet wheel circumferentially, and wherein the body is configured to be adapted to be grasped by one hand when operating the ratchet tool.

15. The ratchet tool as claimed in claim 12, wherein the body includes two grip portions extending in different directions.

16. The ratchet tool as claimed in claim 9, wherein the at least one shifter includes two shifters, and wherein the two shifters are arranged in a spaced relationship.

17. The ratchet tool as claimed in claim 16, wherein the first through hole has a hexagonal cross section, and wherein a portion of the shaft extending between the two shifters has a hexagonal cross section.

18. The ratchet tool as claimed in claim 7 further comprising a detent ball selectively positioning the at least one shifter in relation to the seat between the first, the second, and the third positions disposed between the seat and the at least one shifter, wherein the detent ball is adjacent to and urged by a resilient member to a first positioning hole, a second positioning hole, and a third positioning hole selectively upon rotating the at least one shifter to the first position, the second position, and the third position, wherein the seat defines a cavity and the resilient member is received by the cavity, and wherein the at least one shifter includes a side defining the first positioning hole, the second positioning hole, and the third positioning hole.

19. The ratchet tool as claimed in claim 18, wherein the end of the seat defines a receptacle communicating with the first recess and the second recess, wherein the receptacle includes a resilient member disposed therein, and wherein the resilient member is retained between the first and the second pawls and has one end being adjacent to and urging against the first pawl and another end being adjacent to and urging against the second pawl.

20. The ratchet tool as claimed in claim 1, wherein the pushing member has a depth greater than depths of the first and second protrusions.
